(19) United States
(12) Patent Application Publication
(10) Pub. No.: US 2026/0204468 A1
(43) Pub. Date: Jul. 16, 2026

(54) PLANAR INDUCTOR AND METHOD FOR MANUFACTURING THE SAME

(71) Applicant: National Tsing Hua University, Hsinchu City (TW)

(72) Inventors: King Yuen Wong, Hsinchu City (TW); Shuo-Hung Hsu, Hsinchu City (TW)

(73) Assignee: National Tsing Hua University, Hsinchu City (TW)

(21) Appl. No.: 19/190,812

(22) Filed: Apr. 28, 2025

(30) Foreign Application Priority Data
Jan. 14, 2025 (TW) 114101418

(51) Int. Cl. H01F 27/28; H01F 41/04

(52) U.S. Cl. CPC H01F 27/2804; H01F 41/041; H01F 2027/2809

(57) ABSTRACT

A planar inductor of the disclosure includes a first substrate, a second substrate, a plurality of strip conductors, a plurality of second strip conductors, a first planarization layer, a second planarization layer, a first magnetic layer, at least one first bonding pad and at least one second bonding pad. The first planarization layer covers the first strip conductors disposed on the first substrate. The second planarization layer covers the second strip conductors disposed on the second substrate. The first magnetic layer is disposed on the first planarization layer. The at least one first bonding pad is disposed on the first substrate. The at least one second bonding pad is disposed on the second substrate. The at least one first bonding pad is used to electrically bond with the at least one second bonding pad, enabling electrical conduction between the first strip conductors and the second strip conductors.

### CROSS-REFERENCE TO RELATED APPLICATION

This application claims the priority benefit of Taiwan application serial no. 114101418, filed on Jan. 14, 2025. The entirety of the above-mentioned patent application is hereby incorporated by reference herein and made a part of this specification.

### BACKGROUND

### Technical Field

The disclosure relates to an inductor, and in particular to a planar inductor.

### Description of Related Art

Artificial Intelligence (AI) applications is becoming increasingly important. To achieve high computing performance, AI chips (such as GPUs and CPUs) consume up to 1000W of power during operation. To supply power to AI chips, a switch mode power supply (SMPS) with high conversion efficiency is required to down-convert the input voltage of 12V to a supply voltage of 1V. In the traditional point-of-load (POL) architecture, the power wiring from the SMPS to the AI chip causes high power loss.

In the power conversion system of AI chips, the switching frequency of the SMPS has been significantly increased to minimize the size of inductors and capacitors. This allows the wiring distance from the SMPS to the AI chip to be reduced and a stacked module can be used to provide a compact SMPS. However, key challenges of the inductor in SMPSs that power AI chips includes the need for high switching frequencies (e.g., tens of MHz), high inductance value, low on-resistance, high heat dissipation performance, and compact size.

### SUMMARY

The disclosure provides a planar inductor, which has the characteristics of high switching frequency, high inductance value, low on-resistance, high heat dissipation performance and compact size, and a manufacturing method thereof.

A planar inductor of the disclosure includes a first substrate, a second substrate, plurality of strip conductors, a plurality of second strip conductors, a first planarization layer, a second planarization layer, a first magnetic layer, at least one first bonding pad and at least one second bonding pad. The first substrate and the second substrate are overlapped with each other. The plurality of first strip conductors are disposed on the first substrate. The plurality of second strip conductors are disposed on the second substrate. The first planarization layer is disposed on the first substrate and covers the plurality of first strip conductors. The second planarization layer is disposed on the second substrate and covers the plurality of second strip conductors. The first magnetic layer is disposed on the first planarization layer. The at least one first bonding pad is disposed on the first substrate and electrically connected to the plurality of first strip conductors. The at least one second bonding pad is disposed on the second substrate and electrically connected to the plurality of second strip conductors. The at least one first bonding pad is used to electrically bond with the at least one second bonding pad, enabling electrical conduction between the plurality of first strip conductors and the plurality of second strip conductors.

A method for manufacturing a planar inductor of the disclosure includes forming a plurality of first strip conductors on a first substrate, forming a first planarization layer on the first substrate to cover the plurality of first strip conductors, forming a first magnetic layer on the first planarization layer, forming at least one first bonding pad on the first substrate, forming a plurality of second strip conductors on a second substrate, forming a second planarization layer on the second substrate to cover the plurality of second strip conductors, forming at least one second bonding pad on the second substrate, and performing a bonding process of the at least one first bonding pad and the at least one second bonding pad to assemble the first substrate and the second substrate. The at least one first bonding pad is electrically connected to the plurality of first strip conductors. The at least one second bonding pad is electrically connected to the plurality of second strip conductors. The plurality of first strip conductors are electrically connected to the plurality of second strip conductors.

Based on the above, in a planar inductor and a manufacturing method thereof according to an embodiment of the disclosure, a first substrate is provided with a plurality of first strip conductors and at least one first bonding pad electrically connected to each other, and a second substrate is provided with a plurality of second strip conductors and at least one second bonding pad electrically connected to each other. Through the electrical bonding between the at least one first bonding pad and the at least one second bonding pad, electrical conduction can be achieved between the plurality of first strip conductors and the plurality of second strip conductors on opposite sides of the magnetic layer. Accordingly, in addition to providing greater flexibility in the layout of the strip conductors, the overall film layer stack can also be made more compact. The inductance value of the planar inductor can be increased while maintaining its compact size.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic top view of a planar inductor according to a first embodiment of the disclosure.

FIG. 1B is a schematic bottom view of the planar inductor according to the first embodiment of the disclosure.

FIG. 2A and FIG. 2B are schematic cross-sectional views of the planar inductor FIG. 1A and FIG. 1B.

FIG. 3A to FIG. 3E are schematic cross-sectional views of a manufacturing process of the planar inductor of FIG. 2A.

FIG. 4A to FIG. 4G are schematic cross-sectional views of a manufacturing process of the planar inductor of FIG. 2B.

FIG. 5A is a schematic top view of a planar inductor according to a second embodiment of the disclosure.

FIG. 5B is a schematic bottom view of the planar inductor according to the second embodiment of the disclosure.

FIG. 6 is a schematic cross-sectional view of the planar inductor of FIG. 5A and FIG. 5B.

FIG. 7A to FIG. 7B are schematic cross-sectional views of a partial manufacturing process of the planar inductor of FIG. 6.

FIG. 8A is a schematic top view of a planar inductor according to a third embodiment of the disclosure.

FIG. 8B is a schematic bottom view of the planar inductor according to the third embodiment of the disclosure.

FIG. 9A and FIG. 9B are schematic cross-sectional views of the planar inductor FIG. 8A and FIG. 8B.

FIG. 10A to FIG. 10D and FIG. 11 are schematic cross-sectional views of a partial manufacturing process of the planar inductor of FIG. 9A and FIG. 9B.

FIG. 12 is a schematic top view of a planar inductor according to a fourth embodiment of the disclosure.

FIG. 13A and FIG. 13B are schematic cross-sectional views of the planar inductor of FIG. 12.

FIG. 14 is a schematic cross-sectional view of a planar inductor according to a fifth embodiment of the disclosure.

### DESCRIPTION OF THE EMBODIMENTS

The exemplary embodiments of the present invention will now be described in detail with reference to the accompanying drawings. Wherever possible, the same reference numerals are used in the drawings and descriptions to denote the same or similar parts.

The aforementioned technical contents, features and effects of the present invention will be clearly presented in the following detailed description of a preferred embodiment with reference to the drawings. The directional terms used in the following embodiments, such as up, down, left, right, front, or rear, are for reference to the directions indicated in the accompanying drawings. Therefore, these directional terms are used for explanation purposes and not for limiting the scope of the invention.

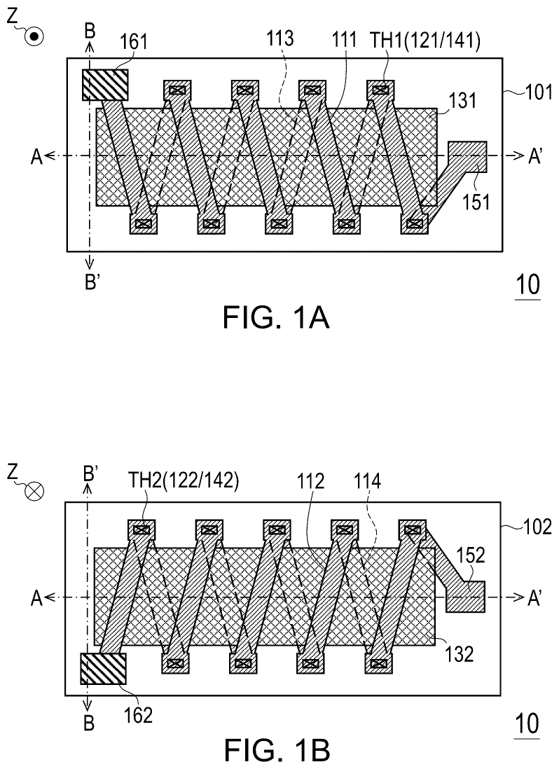

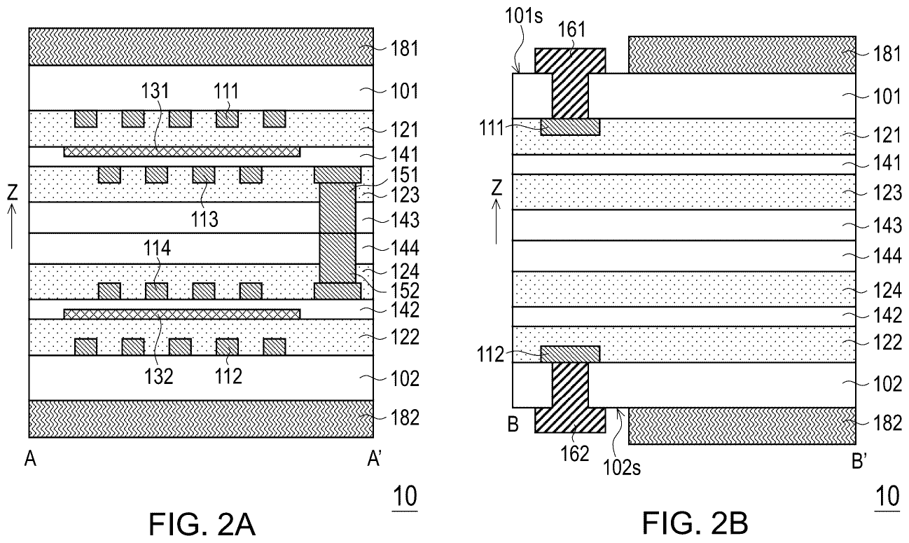

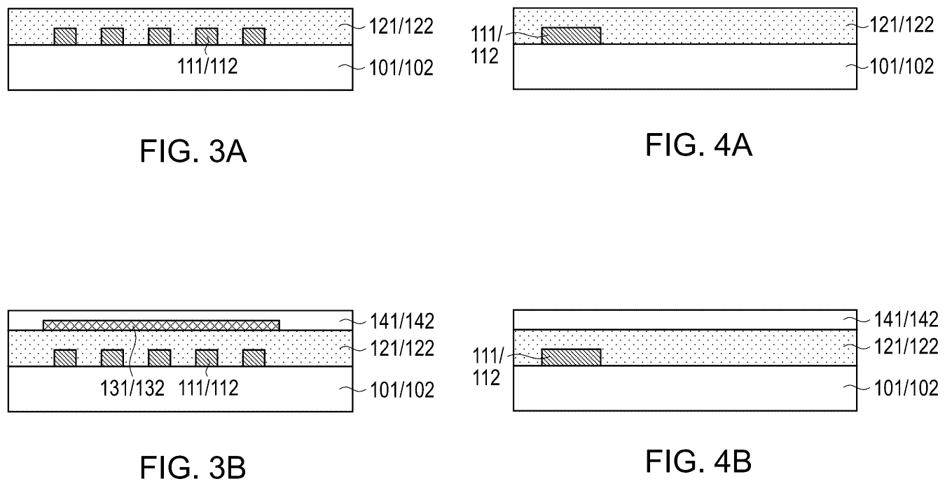

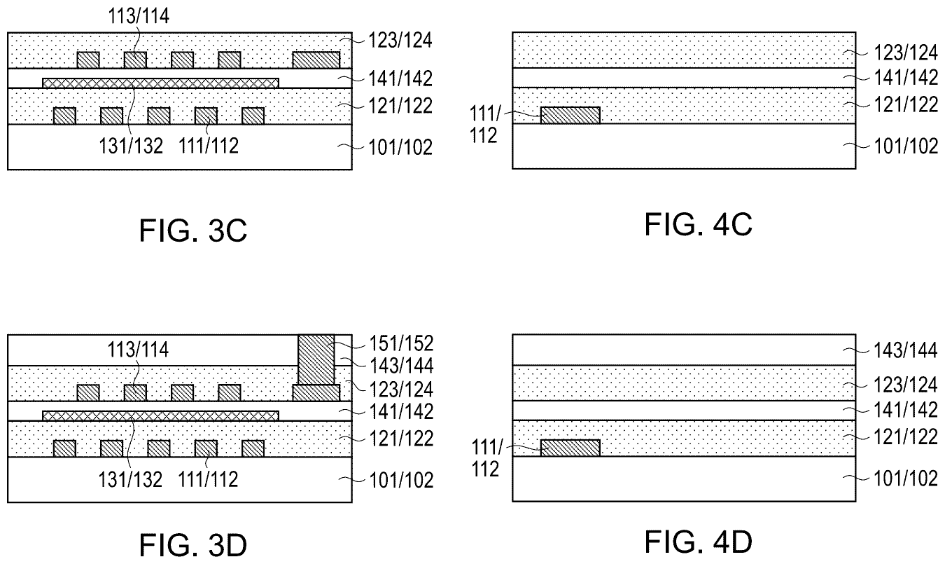

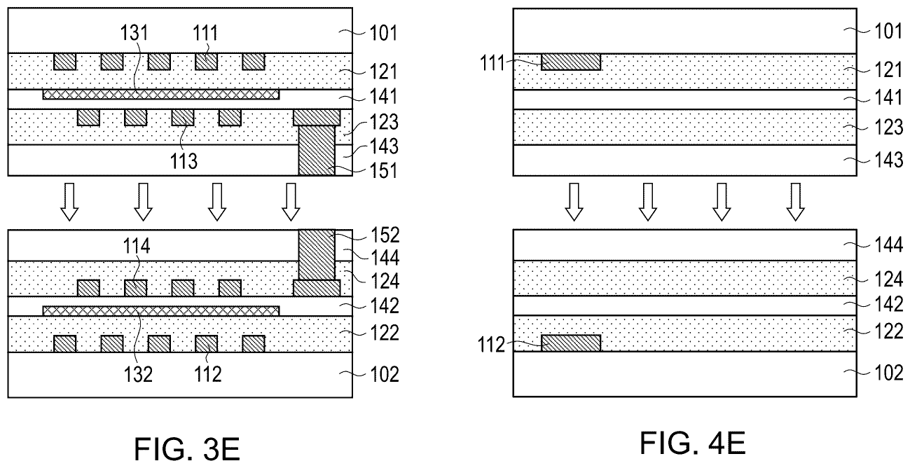

FIG. 1A is a schematic top view of a planar inductor according to a first embodiment of the disclosure. FIG. 1B is a schematic bottom view of the planar inductor according to the first embodiment of the disclosure. FIG. 2A and FIG. 2B are schematic cross-sectional views of the planar inductor of FIG. 1A and FIG. 1B. FIG. 3A to FIG. 3E are schematic cross-sectional views of a manufacturing process of the planar inductor of FIG. 2A. FIG. 4A to FIG. 4G are schematic cross-sectional views of a manufacturing process of the planar inductor of FIG. 2B. FIG. 2A corresponds to the section line A-A′ in FIG. 1A and FIG. 1B. FIG. 2B corresponds to the section line B-B′ in FIG. 1A and FIG. 1B.

Referring to FIG. 1A to FIG. 2B, a planar inductor 10 includes a substrate 101, a substrate 102, a plurality of strip conductors 111, a plurality of strip conductors 112, a plurality of strip conductors 113, a plurality of strip conductors 114, a magnetic layer 131, and a magnetic layer 132. In the embodiment, the plurality of strip conductors 111, the plurality of strip conductors 113 and the magnetic layer 131 may be disposed on the substrate 101, and the plurality of strip conductors 112, the plurality of strip conductors 114 and the magnetic layer 132 may be disposed on the substrate 102. In order to improve the heat dissipation efficiency of the planar inductor 10 and reduce the coupling loss of the substrate, the substrate 101 and the substrate 102 can each be a substrate with high thermal conductivity, such as an aluminum nitride (AlN) substrate, a high resistivity Si substrate or a silicon carbide (SiC) substrate, but the disclosure is not limited thereto. For example, a surface of the strip conductor may be electroplated with a copper layer, a gold layer or other low-resistivity conductor material layer with a film thickness greater than or equal to 10 μm and less than or equal to 30 μm, but the disclosure is not limited thereto.

In detail, the plurality of strip conductors 111 are disposed on the substrate 101 and are covered by a planarization layer 121. The magnetic layer 131 is disposed on the planarization layer 121 and is covered by an isolation layer 141. The plurality of strip conductors 113 are disposed on the isolation layer 141 and covered by another planarization layer 123. The plurality of strip conductors 112 are disposed on the substrate 102 and covered by a planarization layer 122. The magnetic layer 132 is disposed on the planarization layer 121 and is covered by an isolation layer 142. The plurality of strip conductors 114 are disposed on the isolation layer 142 and covered by another planarization layer 124. That is, the magnetic layer 131 is located between the plurality of strip conductors 111 and the plurality of strip conductors 113, and the magnetic layer 132 is located between the plurality of strip conductors 112 and the plurality of strip conductors 114. It is particularly noted that by covering the magnetic layer 131 and the magnetic layer 132 with the isolation layer 141 and the isolation layer 142, respectively, the conductivity loss due to electrical leakage of the magnetic layers can be prevented.

The configuration of the planarization layers 121 and 122 can effectively improve the film flatness of the magnetic layers 131 and 132, thereby enhancing the polarization characteristics of the magnetic layers and achieving high permeability of the magnetic layers at a frequency of tens of MHz. Preferably, the thickness of the planarization layer may be greater than or equal to 100 nm and less than or equal to 300 nm. The material of the magnetic layer 131 and the magnetic layer 132 includes, for example, a high magnetic material such as Cadmium Zinc Telluride (CZT), Iron-Nickel (NiFe) compound, or Cobalt Iron Boron (CoFeB), but the disclosure is not limited thereto. The material of the planarization layers 121 to 124 includes, for example, benzocyclobutene (BCB) polymer or spin-on glass (SOG), but the disclosure is not limited thereto.

In the embodiment, two opposite ends of each strip conductor 113 can be electrically connected to the corresponding two strip conductors 111, respectively, through the two through holes TH1 of the planarization layer 121 and the isolation layer 141, and two opposite ends of each strip conductor 114 can be electrically connected to the corresponding two strip conductors 112, respectively, through the two through holes TH2 of the planarization layer 122 and the isolation layer 142. More specifically, the plurality of strip conductors 111 and the plurality of strip conductors 113 are alternately connected in series along an arrangement direction to form a coil structure surrounding the magnetic layer 131, and the plurality of strip conductors 112 and the plurality of strip conductors 114 are alternately connected in series along an arrangement direction to form a coil structure surrounding the magnetic layer 132.

Furthermore, the planar inductor 10 further includes a bonding pad 151 and a bonding pad 152. The bonding pad 151 is disposed on the substrate 101 and electrically connected to the plurality of strip conductors 111 and the plurality of strip conductors 113. The bonding pad 152 is disposed on 102 and electrically connected to the plurality of strip conductors 112 and the plurality of strip conductors 114. In the embodiment, the bonding pad 151 may be disposed on the isolation layer 141 and penetrates the planarization layer 123, and the bonding pad 152 may be disposed on the isolation layer 142 and penetrates the planarization layer 124, but the disclosure is not limited thereto.

It is particularly noted that the bonding pads 151 and 152 are electrically bonded to each other, enabling electrical conduction between the plurality of strip conductors 111 and the plurality of strip conductors 113 on the substrate 101 and the plurality of strip conductors 112 and the plurality of strip conductors 114 on the substrate 102. In a stacking direction (e.g., direction Z) of the substrate 101 and the substrate 102, the inductor structure formed by the magnetic layer 131, the plurality of strip conductors 111 and the plurality of strip conductors 113 overlaps the inductor structure formed by the magnetic layer 132, the plurality of strip conductors 112 and the plurality of strip conductors 114, and the two inductor structures are electrically connected in series via the bonding relationship between the bonding pads 151 and 152. With such a stacking design, the inductance value of the planar inductor 10 can be increased while maintaining its compact size.

It should be understood that in the embodiment, although the number of the series-connected inductor structures is described by taking two layers as an example, in other embodiments, the number of the inductor structures can be adjusted according to actual application requirements, such as one or more than three.

In order to avoid conductivity loss in the magnetic layer 131 and the magnetic layer 132, an isolation layer 143 and an isolation layer 144 may be disposed between the two magnetic layers 131 and 132, wherein the isolation layer 143 and the isolation layer 144 cover the planarization layer 123 and the planarization layer 124 respectively. Therefore, the bonding pad 151 and the bonding pad 152 have to further penetrate the isolation layer 143 and the isolation layer 144 to achieve electrical bonding between the two.

The isolation layer 141, the isolation layer 142, the isolation layer 143, and the isolation layer 144 includes, for example, silicon dioxide or silicon nitride. Preferably, the thickness of the isolation layer may be greater than or equal to 20 nm and less than or equal to 300 nm. It is particularly noted that, in the embodiment, the isolation layer 143 and the isolation layer 144 may simultaneously serve as a bonding material layer between the substrate 101 and the substrate 102 to achieve assembly of the two substrates, but the disclosure is not limited thereto.

The planar inductor 10 further includes a pad 161 and a pad 162. In the embodiment, the pad 161 is disposed on a surface 101s of one side of the substrate 101 facing away from the bonding pad 151, and penetrates the substrate 101 to electrically connect the plurality of strip conductors 111. The pad 162 is disposed on a surface 102s of one side of the substrate 102 facing away from the bonding pad 152, and penetrates the substrate 102 to electrically connect the plurality of strip conductors 112. That is, the pads 161 and the pads 162 are respectively disposed on two opposite sides of the planar inductor 10 along the direction Z, but the disclosure is not limited thereto.

In order to further improve the heat dissipation efficiency, the planar inductor 10 may be selectively provided with a heat sink 181 and a heat sink 182. In the embodiment, the heat sink 181 may be disposed on the surface 101s of the substrate 101 facing away from the plurality of strip conductors 111, and the heat sink 182 may be disposed on the surface 102s of the substrate 102 facing away from the plurality of strip conductors 112.

The following is an exemplary description of a method for manufacturing the planar inductor 10.

Referring to FIG. 3A and FIG. 4A, first, sequentially forming a plurality of strip conductors 111 and a planarization layer 121 on a substrate 101, wherein the planarization layer 121 covers the plurality of strip conductors 111. Similarly, sequentially forming a plurality of strip conductors 112 and a planarization layer 122 on the substrate 102, wherein the planarization layer 122 covers the plurality of strip conductors 112. Referring to FIG. 3B and FIG. 4B, then, sequentially forming a magnetic layer 131 and an isolation layer 141 on the planarization layer 121, wherein the isolation layer 141 covers the magnetic layer 131. Similarly, sequentially forming a magnetic layer 132 and an isolation layer 142 on the planarization layer 122, wherein the isolation layer 142 covers the magnetic layer 132.

Referring to FIG. 3C and FIG. 4C, after the isolation layer 141 is formed, sequentially forming a plurality of strip conductors 113 and a planarization layer 123 on the isolation layer 141, wherein the planarization layer 123 covers the plurality of strip conductors 113. Similarly, after the isolation layer 142 is formed, sequentially forming a plurality of strip conductors 114 and a planarization layer 124 on the isolation layer 142, wherein the planarization layer 124 covers the plurality of strip conductors 114. Referring to FIG. 3D and FIG. 4D, next, forming an isolation layer 143 on the planarization layer 123, and forming an isolation layer 144 on the planarization layer 124. It is particularly noted that after the isolation layer 143 and the isolation layer 144 are fabricated, forming a bonding pad 151 penetrating the isolation layer 143 and a portion of the planarization layer 123, and forming a bonding pad 152 penetrating the isolation layer 144 and a portion of the planarization layer 124.

Referring to FIG. 3E and FIG. 4E, after the bonding pad 151 and the bonding pad 152 ar e fabricated, performing a bonding process of the bonding pad 151 and the bonding pad 152 to assemble the substrate 101 and the substrate 102, enabling electrical conduction between the plurality of strip conductors 113 on the substrate 101 and the plurality of strip conductors 114 on the substrate 102.

Next, as shown in FIG. 4F, forming a hole 101h in the substrate 101 to expose a portion of the strip conductor 111, and forming a hole 102h in the substrate 102 to expose a portion of the strip conductor 112. Referring to FIG. 4G, after the hole 101h is formed, forming a pad 161 on the surface 101s of the substrate 101, and the pad 161 is electrically connected to the strip conductor 111 through the hole 101h of the substrate 101. Similarly, after the hole 102h is formed, forming a pad 162 on the surface 102s of the substrate 102, and the pad 162 is electrically connected to the strip conductor 112 through the hole 102h of the substrate 102. At this point, the fabrication of the planar inductor 10 shown in FIG. 2A and FIG. 2B is completed.

In the embodiment, a plurality of strip conductors 111, 113 and bonding pads 151 electrically connected to each other are disposed on the substrate 101 of the planar inductor 10, and a plurality of strip conductors 112, 114 and bonding pads 152 electrically connected to each other are disposed on the substrate 102. Through the electrical bonding of the bonding pad 151 and the bonding pad 152, electrical conduction between the plurality of strip conductors on different substrates can be achieved. Accordingly, in addition to providing greater flexibility in the layout of the strip conductors, the overall film layer stack can also be more compact. The inductance value of the planar inductor 10 can be increased while maintaining its compact size.

Other embodiments will be listed below to explain the present disclosure in detail, wherein the same components will be marked with the same symbols, and the description of the same technical content will be omitted. For the omitted parts, please refer to the aforementioned embodiments and will not be repeated below.

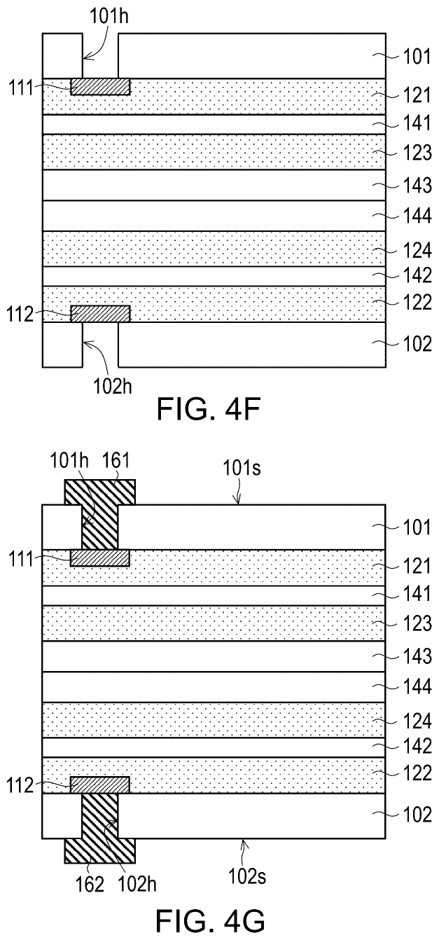

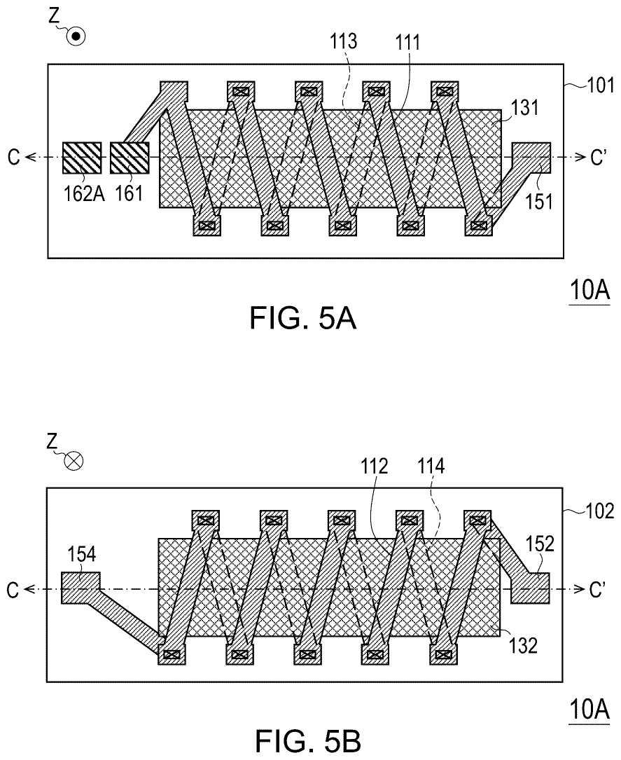

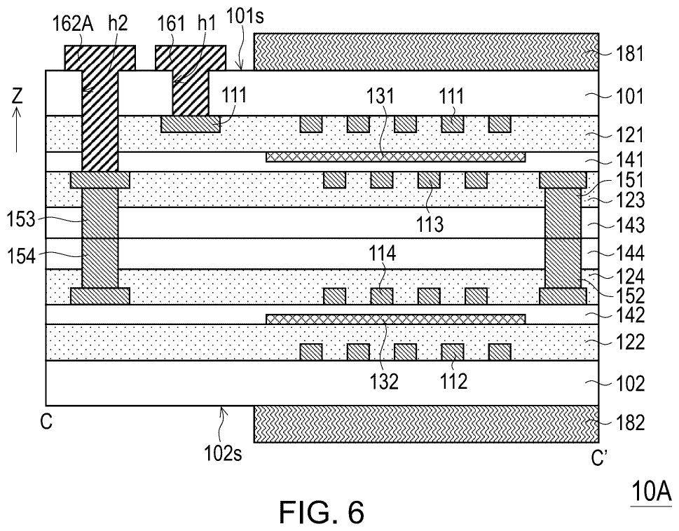

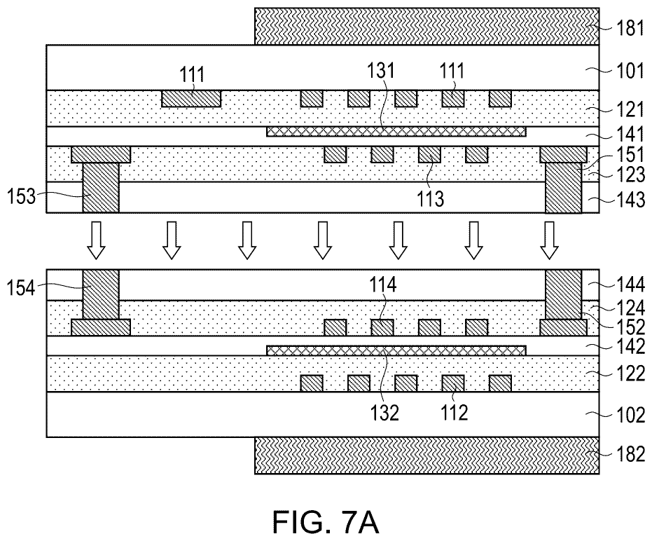

FIG. 5A is a schematic top view of a planar inductor according to a second embodiment of the disclosure. FIG. 5B is a schematic bottom view of the planar inductor according to the second embodiment of the disclosure. FIG. 6 is a schematic cross-sectional view of the planar inductor of FIG. 5A and FIG. 5B. FIG. 7A to FIG. 7B are schematic cross-sectional views of a partial manufacturing process of the planar inductor of FIG. 6. FIG. 6 corresponds to the section line C-C′ in FIG. 5A and FIG. 5B.

Referring to FIGS. 5A, 5B and 6, the difference between a planar inductor 10A of the embodiment and the planar inductor 10 of FIGS. 1A to 2B lies in that the configuration of the pads is different. Specifically, in the embodiment, the pad 161 and the pad 162A are disposed on the same side of the planar inductor 10A, for example, on the surface 101s of the substrate 101.

In detail, in the embodiment, a bonding pad 153 penetrating the isolation layer 143 and the planarization layer 123 may be further disposed on the substrate 101 of the planar inductor 10A, and a bonding pad 154 penetrating the isolation layer 144 and the planarization layer 124 may be further disposed on the substrate 102. The bonding pad 153 and the bonding pad 154 are electrically bonded to each other. The pad 162A penetrates the substrate 101, the planarization layer 121, and the isolation layer 141 to be electrically connected to the bonding pad 153. Accordingly, the electrical connection between the pad 162A and the plurality of strip conductors 112 and 114 on the substrate 102 is achieved.

Therefore, in the manufacturing process of the planar inductor 10A of the embodiment, the assembly step of the substrate 101 and the substrate 102 includes not only the electrical bonding of the bonding pads 151 and 152, but also the electrical bonding of the bonding pads 153 and 154, as shown in FIG. 7A. In addition, after assembling the two substrates and before forming the bonding pads, the method for manufacturing the planar inductor 10A includes forming a hole h1 in the substrate 101 to expose a portion of the strip conductor 111 and forming a hole h2 in the substrate 101, the planarization layer 121 and the isolation layer 141 to expose the bonding pad 153, as shown in FIG. 7B. Finally, forming a pad 161 and a pads 162A on the surface 101s of the substrate 101, wherein the pad 161 is electrically connected to the strip conductor 111 through the hole h1, and the pad 162A is electrically connected to the bonding pads 153 through the hole h2, as shown in FIG. 6.

In the embodiment, since other manufacturing steps of the planar inductor 10A are similar to those of the planar inductor 10 in FIGS. 2A and 2B, detailed descriptions about the manufacturing process of other components or film layers can be found in the relevant paragraphs of the aforementioned embodiment and will not be repeated here.

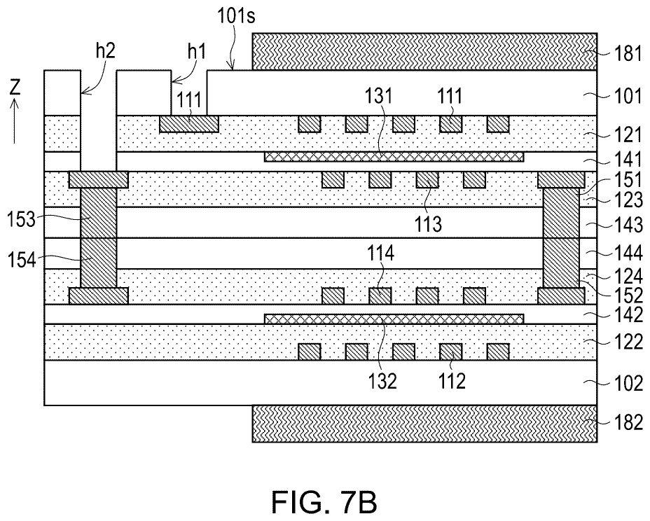

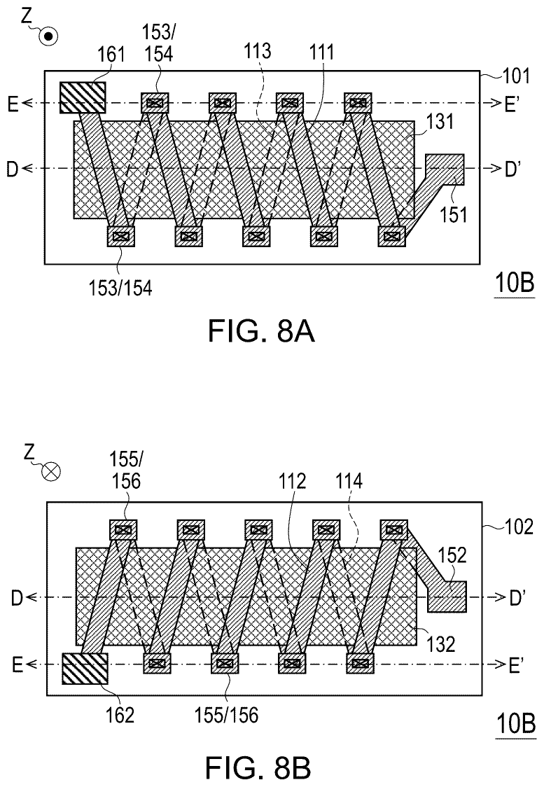

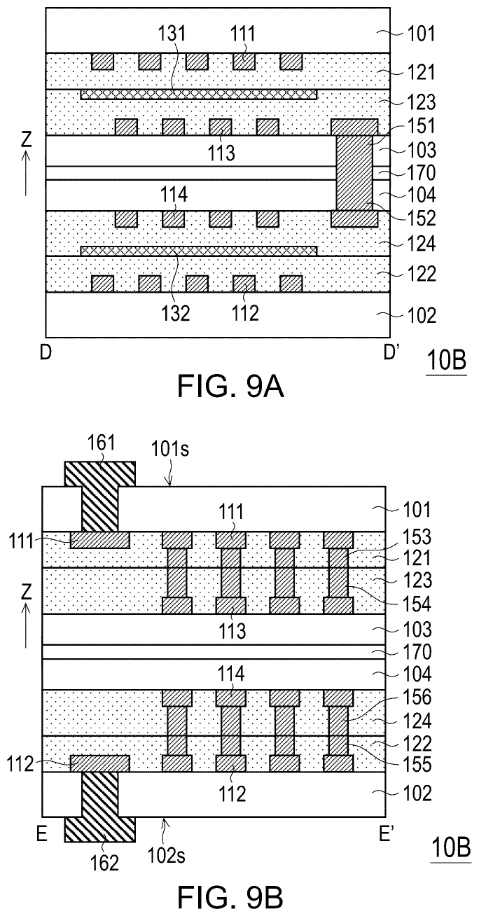

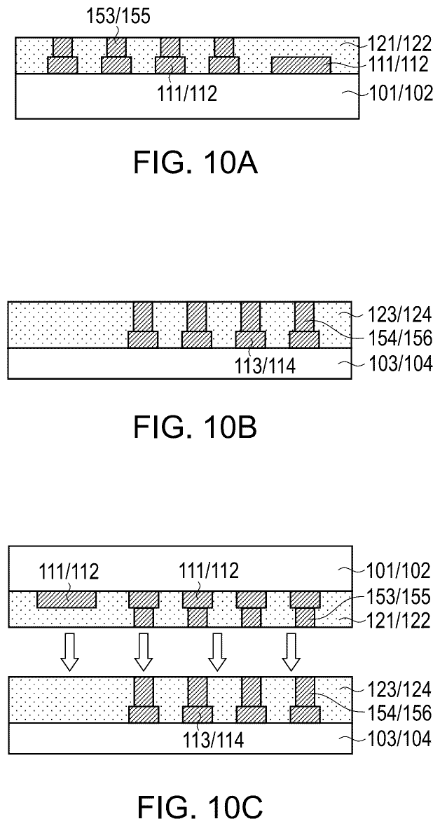

FIG. 8A is a schematic top view of a planar inductor according to a third embodiment of the disclosure. FIG. 8B is a schematic bottom view of the planar inductor according to the third embodiment of the disclosure. FIG. 9A and FIG. 9B are schematic cross-sectional views of the planar inductor of FIG. 8A and FIG. 8B. FIG. 10A to FIG. 10D and FIG. 11 are schematic cross-sectional views of a partial manufacturing process of the planar inductor of FIG. 9A and FIG. 9B. FIG. 9A corresponds to the section line D-D′ in FIG. 8A and FIG. 8B. FIG. 9B corresponds to the section line E-E′ in FIG. 8A and FIG. 8B.

Referring to FIG. 8A to FIG. 9B, the difference between a planar inductor 10B of the embodiment and the planar inductor 10 of FIG. 1A to FIG. 2B lies in that the number of substrates is different. In the embodiment, the planar inductor 10B may further include a substrate 103 and a substrate 104 disposed between the magnetic layer 131 and the magnetic layer 132. For example, the plurality of strip conductors 113 may be disposed on the substrate 103, and the plurality of strip conductors 114 may be disposed on the substrate 104. That is, the magnetic layer 131 is located between the substrate 101 and the substrate 103, and the magnetic layer 132 is located between the substrate 102 and the substrate 104.

Therefore, the bonding pad 151 of the embodiment penetrates the substrate 103 (not the isolation layer 143 and the planarization layer 123 in FIG. 2A) to electrically connect the strip conductor 113, and the bonding pad 152 penetrates the substrate 104 (not the isolation layer 144 and the planarization layer 124 in FIG. 2A) to electrically connect the strip conductor 114.

In the embodiment, the planar inductor 10B further includes a bonding material layer 170 between the substrate 103 and the substrate 104 to connect the substrate 103 and the substrate 104. In order to improve the heat dissipation efficiency of the planar inductor 10B and reduce the coupling loss of the substrate, the substrate 103 and the substrate 104 can each be a substrate with high thermal conductivity, such as an aluminum nitride (AlN) substrate, a high resistivity Si substrate or a silicon carbide (SiC) substrate, but the disclosure is not limited thereto. The material of the bonding material layer 170 includes, for example, silicon dioxide, silicon nitride, copper or aluminum nitride (AlN), but the disclosure is not limited thereto.

Furthermore, in the embodiment, the planar inductor 10B further includes a plurality of bonding pads 153, a plurality of bonding pads 154, a plurality of bonding pads 155 and a plurality of bonding pads 156. The plurality of bonding pads 153 are disposed on the substrate 101 and electrically connected to the plurality of strip conductors 111. The plurality of bonding pads 154 are disposed on the substrate 103 and electrically connected to the plurality of strip conductors 113. The plurality of bonding pads 155 are disposed on the substrate 102 and electrically connected to the plurality of strip conductors 112. The plurality of bonding pads 156 are disposed on the substrate 104 and electrically connected to the plurality of strip conductors 114.

It is particularly noted that, unlike the planar inductor 10 of FIG. 2A, in the embodiment, the electrical conduction between the plurality of strip conductors 111 and the plurality of strip conductors 113 is achieved by electrical bonding between the plurality of bonding pads 153 on the substrate 101 and the plurality of bonding pads 154 on the substrate 103, while the electrical conduction between the plurality of strip conductors 112 and the plurality of strip conductors 114 is achieved by electrical bonding between the plurality of bonding pads 155 on the substrate 102 and the plurality of bonding pads 156 on the substrate 104. On the other hand, the planar inductor 10B of the embodiment is not provided with the two heat sinks 181 and 182 as shown in FIG. 2A and FIG. 2B.

The following will exemplarily describe the parts of the manufacturing method of the planar inductor 10B that are different from the planar inductor 10 shown in FIGS. 2A and 2B.

Referring to FIG. 10A, after a plurality of strip conductors 111 and a planarization layer 121 are sequentially formed on a substrate 101, forming a plurality of bonding pads 153 on the substrate 101, wherein the plurality of bonding pads 153 penetrate the planarization layer 121 to electrically connect the plurality of strip conductors 111, respectively. Similarly, after a plurality of strip conductors 112 and a planarization layer 122 are sequentially formed on the substrate 102, forming a plurality of bonding pads 155 on the substrate 102, wherein the plurality of bonding pads 155 penetrate the planarization layer 122 to electrically connect the plurality of strip conductors 112, respectively.

Referring to FIG. 10B, the method for manufacturing the planar inductor 10B further includes sequentially forming a plurality of strip conductors 113, a planarization layer 123, and a plurality of bonding pads 154 on the substrate 103, and sequentially forming a plurality of strip conductors 114, a planarization layer 124, and a plurality of bonding pads 156 on the substrate 104. The plurality of bonding pads 154 penetrate the planarization layer 123 to electrically connect the plurality of strip conductors 113 respectively. The plurality of bonding pads 156 penetrate the planarization layer 124 to electrically connect the plurality of strip conductors 114, respectively.

Next, performing a bonding process of the plurality of bonding pads 153 and the plurality of bonding pads 154 to assemble the substrate 101 and the substrate 103, enabling electrical conduction between the plurality of strip conductors 111 and the plurality of strip conductors 113, as shown in FIG. 10C. Similarly, performing a bonding process of the plurality of bonding pads 155 and the plurality of bonding pads 156 to assemble the substrate 102 and the substrate 104, enabling electrical conduction between the plurality of strip conductors 112 and the plurality of strip conductors 114. As shown in FIG. 9A and FIG. 9B, after the substrates 101 and 103 are assembled, the magnetic layer 131 is located between the plurality of strip conductors 111 and the plurality of strip conductors 113, and is directly covered by the planarization layer 121 and the planarization layer 123. After the substrates 102 and 104 are assembled, the magnetic layer 132 is located between the plurality of strip conductors 112 and the plurality of strip conductors 114, and is directly covered by the planarization layer 122 and the planarization layer 124.

Referring to FIG. 10D and FIG. 11, after the substrates 101 and 103 are assembled and the substrates 102 and 104 are assembled, performing a bonding process of the bonding pad 151 and the bonding pad 152 to assemble the substrates 103 and 104 and electrically connect the plurality of strip conductors 113 on the substrate 103 and the plurality of strip conductors 114 on the substrate 104.

In the embodiment, since other manufacturing steps of the planar inductor 10B are similar to those of the planar inductor 10 in FIGS. 2A and 2B, detailed descriptions about the manufacturing process of other components (e.g., the pad 161 and the pad 162) or film layers can be found in the relevant paragraphs of the aforementioned embodiment, and will not be repeated here.

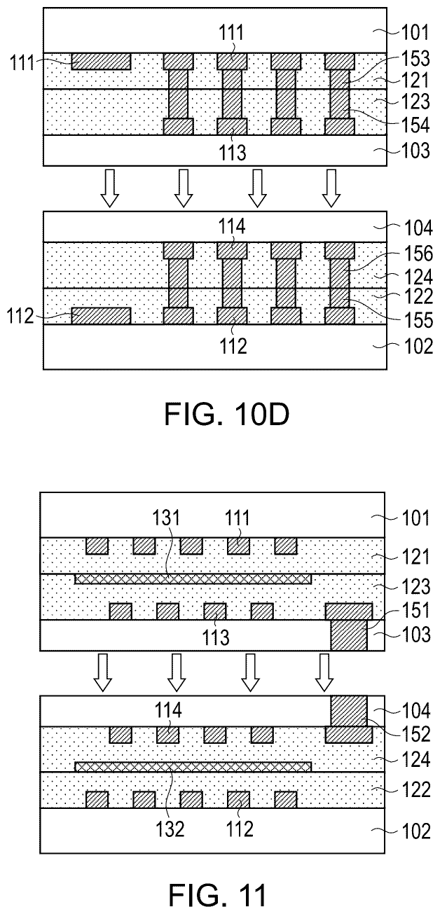

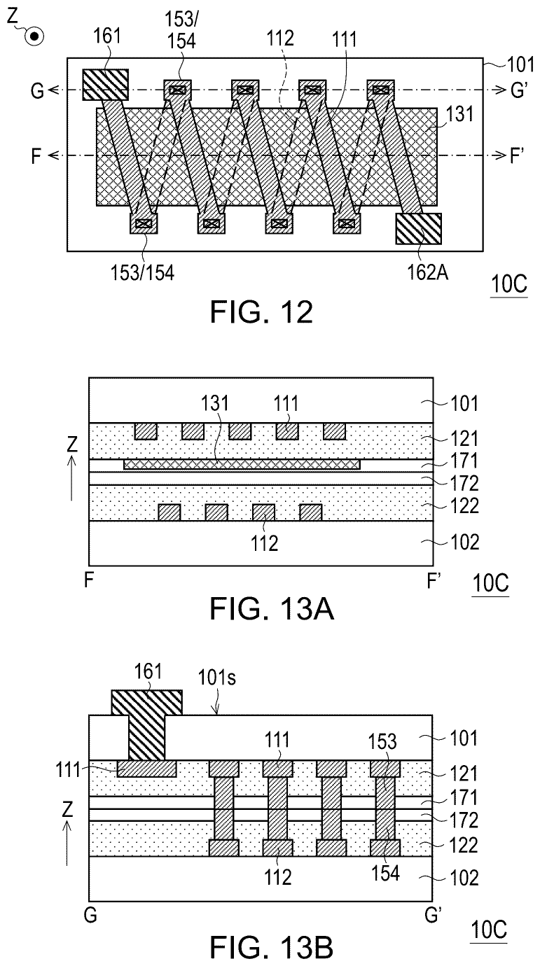

FIG. 12 is a schematic top view of a planar inductor according to a fourth embodiment of the disclosure. FIG. 13A and FIG. 13B are schematic cross-sectional views of the planar inductor of FIG. 12. FIG. 13A corresponds to section line F-F′ in FIG. 12. FIG. 13B corresponds to section line G-G′ in FIG. 12.

Referring to FIGS. 12, 13A and 13B, the main difference between a planar inductor 10C of the embodiment and the planar inductor 10 of FIG. 1A to FIG. 2B lies in that the number of layers of the inductor structure is different. Specifically, the planar inductor 10C is only provided with the inductor structure formed by the magnetic layer 131 and the plurality of strip conductors 111 and 112. In the embodiment, the planar inductor 10C may include a plurality of bonding pads 153 and a plurality of bonding pads 154. The plurality of bonding pads 153 are disposed on the substrate 101 and penetrate the planarization layer 121 to electrically connect the plurality of strip conductors 111, respectively. The plurality of bonding pads 154 are disposed on the substrate 102 and penetrate through the planarization layer 122 to electrically connect the plurality of strip conductors 112, respectively.

It is particularly noted that, unlike the planar inductor 10 of FIG. 2A, in the embodiment, the electrical conduction between the plurality of strip conductors 111 on the substrate 101 and the plurality of strip conductors 112 on the substrate 102 is achieved by electrical bonding between the plurality of bonding pads 153 on the substrate 101 and the plurality of bonding pads 154 on the substrate 102.

After the bonding process of the plurality of bonding pads 153 and the plurality of bonding pads 154 (as shown in FIG. 10C), the magnetic layer 131 is located between the plurality of bonding pads 153 and the plurality of bonding pads 154, and the bonding material layers 171 and 172 are connected between the planarization layers 121 and the planarization layers 122. In t he embodiment, the bonding material layer 171 may directly cover the magnetic layer 131, but the disclosure is not limited thereto. The material of the bonding material layer 171 and the bonding material layer 172 includes, for example, silicon dioxide, silicon nitride, copper, or aluminum nitride (AlN), but the disclosure is not limited thereto.

Similar to the planar inductor 10A in FIG. 6, the pad 161 and the pad 162A of the planar inductor 10C of the embodiment are disposed on the same side of the surface 101s of the substrate 101. Since the connection method between the pad 162A on the substrate 101 and the plurality of strip conductors 112 on the substrate 102 can adopt a structural design similar to that of FIG. 6, the detailed description can be found in the relevant paragraphs of the aforementioned embodiment, which will not be repeated here.

Since only one set of inductor structure is provided between the substrate 101 and the substrate 102 in the embodiment, the distance between the magnetic layer 131 and each of the substrate 101 and the substrate 102 is relatively short, and the substrate 101 and the substrate 102 can each be a substrate with high thermal conductivity, such as an aluminum nitride (AlN) substrate, a high resistivity silicon (high resistivity Si) substrate or a silicon carbide (SiC) substrate. Therefore, the planar inductor 10C of the embodiment may have better heat dissipation efficiency.

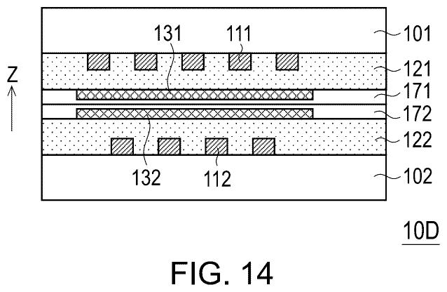

FIG. 14 is a schematic cross-sectional view of a planar inductor according to a fifth embodiment of the disclosure. Referring to FIG. 14, the difference between a planar inductor 10D of the embodiment and the planar inductor 10C of FIG. 13A lies in that the number of magnetic layers is different. In the embodiment, the planar inductor 10D may further include a magnetic layer 132 disposed on the substrate 102. More specifically, the magnetic layer 132 is disposed on the planarization layer 122 and is directly covered by the bonding material layer 172. By arranging two magnetic layers 131 and 132 between the plurality of strip conductors 111 and the plurality of strip conductors 112, the inductance value of the planar inductor 10D can be further increased.

To sum up, in a planar inductor according to an embodiment of the disclosure, a first substrate is provided with a plurality of first strip conductors and at least one first bonding pad electrically connected to each other, and a second substrate is provided with a plurality of second strip conductors and at least one second bonding pad electrically connected to each other. Through the electrical bonding between the at least one first bonding pad and the at least one second bonding pad, electrical conduction can be achieved between the plurality of first strip conductors and the plurality of second strip conductors on opposite sides of the magnetic layer. Accordingly, in addition to providing greater flexibility in the layout of the strip conductors, the overall film layer stack can also be made more compact. The inductance value of the planar inductor can be increased while maintaining its compact size.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A planar inductor, comprising:
a first substrate and a second substrate, overlapped with each other;
a plurality of first strip conductors, disposed on the first substrate;
a plurality of second strip conductors, disposed on the second substrate;
a first planarization layer, disposed on the first substrate and covering the plurality of first strip conductors;
a second planarization layer, disposed on the second substrate and covering the plurality of second strip conductors;
a first magnetic layer, disposed on the first planarization layer;
at least one first bonding pad, disposed on the first substrate and electrically connected to the plurality of first strip conductors, and
at least one second bonding pad, disposed on the second substrate and electrically connected to the plurality of second strip conductors, wherein the at least one first bonding pad is used to electrically bond with the at least one second bonding pad, enabling electrical conduction between the plurality of first strip conductors and the plurality of second strip conductors.

2. The planar inductor according to claim 1, wherein the first substrate and the second substrate are each an aluminum nitride substrate, a high-resistivity silicon substrate or a silicon carbide substrate.

3. The planar inductor according to claim 1, wherein the at least one first bonding pad is a plurality of first bonding pads, the at least one second bonding pad is a plurality of second bonding pads, and the plurality of first bonding pads are electrically bonded to the plurality of second bonding pads respectively.

4. The planar inductor according to claim 3, further comprising:
a second magnetic layer, disposed on the second planarization layer, wherein the first magnetic layer and the second magnetic layer are located between the plurality of first strip conductors and the plurality of second strip conductors; and
a bonding material layer, connecting the first magnetic layer and the second magnetic layer.

5. The planar inductor according to claim 1, further comprising:
a first isolation layer, covering the first magnetic layer;
a plurality of third strip conductors, disposed on the first isolation layer and located between the plurality of first strip conductors and the plurality of second strip conductors;
a third planarization layer, disposed on the first isolation layer and covering the plurality of third strip conductors;
a second magnetic layer, disposed on the second planarization layer;
a second isolation layer, covering the second magnetic layer;
a plurality of fourth strip conductors, disposed on the second isolation layer and located between the plurality of third strip conductors and the plurality of second strip conductors; and
a fourth planarization layer, disposed on the second isolation layer and covering the plurality of fourth strip conductors, wherein the first magnetic layer is located between the plurality of first strip conductors and the plurality of third strip conductors, and the second magnetic layer is located between the plurality of second strip conductors and the plurality of fourth strip conductors.

6. The planar inductor according to claim 1, further comprising:
a third substrate, disposed on one side of the first substrate facing away from the second substrate;
a plurality of third strip conductors, disposed on the third substrate, wherein the first magnetic layer is located between the plurality of first strip conductors and the plurality of third strip conductors;
a plurality of third bonding pads, disposed on the third substrate and electrically connected to the plurality of third strip conductors;
a plurality of fourth bonding pads, disposed on the first substrate and electrically connected to the plurality of first strip conductors, wherein the plurality of third bonding pads are used to electrically bond with the plurality of fourth bonding pads, enabling electrical conduction between the plurality of third strip conductors and the plurality of first strip conductors;
a third planarization layer, disposed on the third substrate and covering the plurality of third strip conductors;
a second magnetic layer, disposed on the second planarization layer;
a fourth substrate, disposed on one side of the second substrate facing away from the first substrate;
a plurality of fourth strip conductors, disposed on the fourth substrate, wherein the second magnetic layer is located between the plurality of second strip conductors and the plurality of fourth strip conductors;
a plurality of fifth bonding pads, disposed on the fourth substrate and electrically connected to the plurality of fourth strip conductors;
a plurality of sixth bonding pads, disposed on the second substrate and electrically connected to the plurality of second strip conductors, wherein the plurality of fifth bonding pads are used to electrically bond with the plurality of sixth bonding pads, enabling electrical conduction between the plurality of fourth strip conductors and the plurality of second strip conductors;
a fourth planarization layer, disposed on the fourth substrate and covering the plurality of fourth strip conductors; and
a bonding material layer, connecting the first substrate and the second substrate, wherein the at least one first bonding pad is a first bonding pad, and the at least one second bonding pad is a second bonding pad.

7. The planar inductor according to claim 6, wherein the first substrate, the second substrate, the third substrate and the fourth substrate are each an aluminum nitride substrate, a high-resistivity silicon substrate or a silicon carbide substrate.

8. The planar inductor according to claim 6, wherein the first planarization layer and the third planarization layer directly cover the first magnetic layer, and the second planarization layer and the fourth planarization layer directly cover the second magnetic layer.

9. The planar inductor according to claim 1, further comprising:
a first pad, disposed on a surface of the first substrate facing away from the at least one first bonding pad and penetrating the first substrate to electrically connect the plurality of first strip conductors; and
a second pad, disposed on a surface of the second substrate facing away from the at least one second bonding pad and penetrating the second substrate to electrically connect the plurality of second strip conductors.

10. The planar inductor according to claim 1, further comprising:
a first pad and a second pad, disposed on a surface of the first substrate facing away from the at least one first bonding pad, wherein the first pad penetrates the first substrate to electrically connect the plurality of first strip conductors, and the second pad penetrates the first substrate to electrically connect the plurality of second strip conductors.

11. The planar inductor according to claim 1, wherein a material of the first planarization layer and the second planarization layer includes benzocyclobutene polymer or spin-on glass.

12. The planar inductor according to claim 1, further comprising:
a first heat sink, disposed on a surface of the first substrate facing away from the plurality of first strip conductors; and
a second heat sink, disposed on a surface of the second substrate facing away from the plurality of second strip conductors.

13. A method for manufacturing a planar inductor, comprising:
forming a plurality of first strip conductors on a first substrate;
forming a first planarization layer on the first substrate to cover the plurality of first strip conductors;
forming a first magnetic layer on the first planarization layer;
forming at least one first bonding pad on the first substrate, wherein the at least one first bonding pad is electrically connected to the plurality of first strip conductors;
forming a plurality of second strip conductors on a second substrate;
forming a second planarization layer on the second substrate to cover the plurality of second strip conductors;
forming at least one second bonding pad on the second substrate, wherein the at least one second bonding pad is electrically connected to the plurality of second strip conductors; and
performing a bonding process of the at least one first bonding pad and the at least one second bonding pad to assemble the first substrate and the second substrate, enabling electrical conduction between the plurality of first strip conductors and the plurality of second strip conductors.

14. The method for manufacturing the planar inductor according to claim 13, further comprising:
forming a first isolation layer on the first substrate to cover the first magnetic layer;
forming a plurality of third strip conductors on the first isolation layer;
forming a third planarization layer on the first isolation layer to cover the plurality of third strip conductors;
forming a second magnetic layer on the second planarization layer;
forming a second isolation layer on the second substrate to cover the second magnetic layer;
forming a plurality of fourth strip conductors on the second isolation layer; and
forming a fourth planarization layer on the second isolation layer to cover the plurality of fourth strip conductors.

15. The method for manufacturing a planar inductor according to claim 13, further comprising:
forming a plurality of third strip conductors on a third substrate;
forming a third planarization layer on the third substrate to cover the plurality of third strip conductors;
forming a plurality of third bonding pads on the third substrate, wherein the plurality of third bonding pads are electrically connected to the plurality of third strip conductors;
forming a plurality of fourth bonding pads on the first substrate, wherein the plurality of fourth bonding pads are electrically connected to the plurality of first strip conductors;
performing a bonding process of the plurality of third bonding pads and the plurality of fourth bonding pads to assemble the first substrate and the third substrate, enabling electrical conduction between the plurality of first strip conductors and the plurality of third strip conductors, wherein the first magnetic layer is located between the plurality of first strip conductors and the plurality of third strip conductors after the assembly of the first substrate and the third substrate;
forming a second magnetic layer on the second planarization layer;
forming a plurality of fourth strip conductors on a fourth substrate;
forming a fourth planarization layer on the fourth substrate to cover the plurality of fourth strip conductors;
forming a plurality of fifth bonding pads on the fourth substrate, wherein the plurality of fifth bonding pads are electrically connected to the plurality of fourth strip conductors;
forming a plurality of sixth bonding pads on the second substrate, wherein the plurality of sixth bonding pads are electrically connected to the plurality of second strip conductors; and
performing a bonding process of the plurality of fifth bonding pads and the plurality of sixth bonding pads to assemble the second substrate and the fourth substrate, enabling electrical conduction between the plurality of second strip conductors and the plurality of fourth strip conductors, wherein the second magnetic layer is located between the plurality of second strip conductors and the plurality of fourth strip conductors after the assembly of the second substrate and the fourth substrate,
wherein the at least one first bonding pad is a first bonding pad, the at least one second bonding pad is a second bonding pad, and the bonding process of the first bonding pad and the second bonding pad is after the assembly of the first substrate and the third substrate and the assembly of the second substrate and the fourth substrate.

16. The method for manufacturing a planar inductor according to claim 13, wherein the at least one first bonding pad is a plurality of first bonding pads, the at least one second bonding pad is a plurality of second bonding pads, and the first magnetic layer is located between the plurality of first strip conductors and the plurality of second strip conductors after the bonding process of the plurality of first bonding pads and the plurality of second bonding pads.

17. The method for manufacturing a planar inductor according to claim 16, further comprising:
forming a second magnetic layer on the second planarization layer, wherein after the bonding process of the plurality of first bonding pads and the plurality of second bonding pads, the second magnetic layer is located between the plurality of first strip conductors and the plurality of second strip conductors, and a bonding material layer is connected between the first magnetic layer and the second magnetic layer.
